(19) United States
(12) Patent Application Publication
(10) Pub. No.: US 2005/0199739 A1
(43) Pub. Date: Sep. 15, 2005

(54) Method of forming metal coating with hvof spray gun and thermal spray apparatus

(76) Inventors: Seiji Kuroda, Ibaraki (JP); Takeshi Fukushima, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 10/515,816

(22) PCT Filed: Oct. 9, 2003
(86) PCT No.: PCT/JP03/12983

§ 371 Date: Feb. 1, 2005

(30) Foreign Application Priority Data
Oct. 9, 2002 (JP) 2002-296709

(51) Int. Cl. B05B 1/24

(52) U.S. Cl. 239/13; 239/79; 239/85; 239/433; 239/288; 239/135

(57) ABSTRACT

There are provided a thermal spraying method and a thermal spraying apparatus therefor, in which a gas shroud is disposed in an HVOF thermal spraying gun barrel, the velocity of metallic particles is energized and accelerated with respect to the metallic particle to be thermally sprayed from the gun, and inert gas is supplied into the space defined inside of the shroud through a circumferential slit formed in such a manner as to shield the metallic particles from the atmosphere so as to collide with the surface of a base member, thereby forming a thermally sprayed dense film having a small oxygen content without overheating the base plate by an HVOF method.

### TECHNICAL FIELD

The present invention relates to a thermal spraying technique, in which corrosion resistance or abrasion resistance is applied to the surface of a base plate by forming a corrosion-resistant thermally sprayed metallic film by thermal spraying, so as to prolong the lifetime of a structure or various kinds of industrial equipment and, more particularly, to a metallic film forming method using a high velocity oxy-fuel (hereinafter abbreviated as “HVOF”) thermal spraying gun and a thermal spraying apparatus for the method.

### BACKGROUND ART

It is necessary to prevent (any) corrosion by subjecting a material poor in corrosion resistance to some surface treatment when such a material is used in seawater or in coastal environment even if the material such as steel has excellent characteristics as a structural material. Means for preventing (any) corrosion include many methods for painting, plating and the like. However, the painting or plating has raised problems yet from the viewpoints of durability and lifetime. On the other hand, an attempt has been made to spray corrosion-resistant powder onto the surface of a base plate by thermal spraying at high temperature (for example, flame spraying, plasma spraying, arc spraying and the like), so as to fabricate corrosion resistant film. However, a resultant film has not been satisfactory in regard to density. Therefore, even if a technique for forming a corrosion-resistant film has been adopted and carried out, there has arisen such an ironic result under the current circumstances that the film must be subjected to post-treatment by different means, for example, impregnation of a resin in the film or partial fusion by overheating after the thermal spraying, that is, after the formation of the film.

Furthermore, there has been put into practical use a corrosion-prevention method of a sacrificial anode type in which a material electrochemically less noble than iron such as zinc or aluminum is coated and selectively eluded, to thus protect a steel base member. In this case, although pores in the film cannot raise any problem, it is construed that a corrosion-resistant lifetime can become long if a resin penetrates the film, However, this has raised a problem of an increase in dissolution rate depending upon the mechanical strength and environment of the film, thereby shortening a lifetime of a designed product.

In the meantime, a so-called HVOF thermal spraying method has been put into practical use and has become a focus of attention in recent years, in which material powder is hardly fused but is sprayed to a base member at a high velocity in a softened state, and then, the powder is Instantly welded by kinetic energy, thereby forming a film. For now, this technique is most used to, for example, an abrasion-resistant (superhard) film made of WC—Co cermet. This is because tungsten carbide WC is readily decomposed when it is exposed to, for example, a hot plasma at high temperature; in contrast, WC is much less decomposed at a heat source temperature of about 2,500° C. at the maximum in the case of the HVOF, and further, a dense film is formed at a high velocity. From the above-described example, it has been found that the HVOF has the feature of formation of a dense barrier type film in the atmosphere, and therefore, has the possibility of formation of a dense film made of a corrosion-resistant material.

In view of such circumstances as described above, the inventors of the present application have studied to form dense films made of various kinds of corrosion-resistant alloys by the HVOF thermal spraying method. As a result, it has been found that even if an Ni-based alloy such as Hastelloy is thermal sprayed under a standard condition by a commercially available HVOF thermal spraying apparatus, a considerably dense film excellent in corrosion resistance can be formed. This invention has been patentable already (see Literature 1).

Literature 1 Jpn. Pat. No. 3,069,696, “Corrosion-Resistant Thermally Sprayed Film and Method for Fabricating the Same”

However, a film having satisfactory density could not be made of stainless steel under spraying conditions in which the commercially available HVOF thermal spraying apparatus can operate. When thermal power of combustion flames is increased to enhance the film density, a base member is undesirably overheated, thereby raising a problem of marked oxidation of a film. Thus, the present invention has been accomplished to solve the above-described problems in a contradictory relationship experienced in the prior art according to existing and simple means. In other words, an object of the present invention is to provide a thermally sprayed dense metallic film of low oxidation by using HVOF thermal spraying means without overheating.

### DISCLOSURE OF THE INVENTION

As a result of an earnest study conducted by the inventors of the present invention, it has been found that a cylindrical attachment (hereinafter referred to as “a gas shroud” or simply referred to as “a shroud”) is attached to a commercially available HVOF thermal spraying gun, oxidation of thermally sprayed particles can be suppressed by supplying a great quantity of inert gas into the cylindrical attachment, and further, when the particles are thermally sprayed to the surface of a base plate at an increased particle velocity, a thermally sprayed dense film with remarkably low oxidation can be formed without increasing the temperature of combustion flames very much. These findings have reached the present invention.

That Is to say, according to the present invention, gas shielding means, which has been already used in the field of plasma spraying, is basically used in addition to an HVOF thermal spraying gun, and then, the gas shielding means and the HVOF thermal spraying gun are connected to each other, thereby producing a technical effect which could not be achieved in the prior art, that is, producing an effect of formation of a thermally sprayed dense metallic film having a small oxygen content without overheating a base plate, with an attendant advantage of a remarkably profound significance. In other words, an object of the present invention is to provide an HVOF thermal spraying method equipped with excellent features based on a series of findings and a thermal spraying apparatus therefor.

Specifically, first solving means according to the present invention provides a metallic film forming method by using an HVOF thermal spraying gun, in which a gas shroud having a cylindrical portion formed into a shape in conformity with that of a barrel cylindrical portion of the thermal spraying gun is disposed in the barrel cylindrical portion, Inert gas is supplied into a space defined inside of the shroud in such a manner as to suppress oxidation and energize a particle velocity, and metallic particles are accelerated to collide with a base plate without overheating the base plate, so as to form a thermally sprayed dense film having a low oxygen content at a relatively low temperature, characterized in that: means for supplying the inert gas into the space defined inside of the gas shroud is constituted of a slit formed in a circumferential manner, and can energize the velocity with respect to the metallic particles to be thermally sprayed by the thermal spraying gun and prevent mixture of the atmosphere.

Here, the gas shroud to be used has been already used in thermal spraying at high temperature, for example, in plasma spraying. However, the gas shroud has been used merely for controlling the atmosphere and preventing oxidation of thermally sprayed metal (see Jpn. Pat. Appln. KOKAI Publication No. 224,662/1996), unlike the present invention in which the gas shroud is used as means for increasing a particle velocity. There is no literature which suggests simultaneous achievement of density of a metallic film and a low oxidation by increased velocity achieved by a gas syroud.

A technical report entitled “A Gas Shroud Nozzle for HVOF Spray Deposition”by Pershin V. and three others (on pp. 1305 to 1308 in Proceedings of the 15^{th} International Thermal Spraying Conference held at Nice, France from Mar. 25 to 29, 1998) discloses a test result of the comparative investigation of particle velocities in the case where gas is made to flow in a cylindrical gas shroud and where no gas is made to flow therein after the gas shroud of a water cooling structure having an inside port for introducing nitrogen is disposed in an HVOF thermal spraying gun in such a manner as to surround combustion flames, and in the case where no gas shroud is disposed. As a result, it has been reported that the velocity of the thermally sprayed metallic particle is markedly decreased in the thermal spraying gun having the gas shroud disposed therein in comparison with the thermal spraying gun without any gas shroud. That is to say, the above-described technical report discloses nowhere the suggestion of the achievement of an increase in particle velocity by disposing the gas shroud in the thermal spraying gun, but merely discloses the utterly contrary result. Moreover, U.S. Pat. Nos. 4,869,936, 5,019,429 and 5,151.308 by Moskowitz and Donald disclose a technique in which a gas shroud is disposed in an HVOF thermal spraying apparatus using hydrogen and oxygen as a heat source, so as to form a film excellent in corrosion resistance. This shroud is adapted to shield thermally sprayed particles from the atmosphere by the use of a swirl flow formed by injecting inert gas toward the inner surface of the shroud from numerous nozzles formed inside thereof, but is not intended (i.e., does not produce any effect) to accelerate the particles.

Furthermore, in order to supply the inert gas into the space defined inside of the gas shroud, second solving means according to the present invention provides a metallic film forming method characterized in that an inclination with respect to the spraying direction of the metallic particles to be thermally sprayed is provided at the slit formed in the circumferential manner, and thus, the inert gas is supplied into the space defined inside of the gas shroud along the inclination; and third solving means provides a metallic film forming method characterized in that the inclination is within an angle of 70° with respect to a line perpendicular to the center axis of the shroud cylindrical portion.

Moreover, fourth solving means provides a metallic film forming method characterized in that the inert gas supplying means constituted of the slits formed in the circumferential manner are arranged at a plurality of portions In a lengthwise direction of the gas shroud; and fifth solving means provides a metallic film forming method characterized in that the slits are arranged at two or more portions including a thermal spraying gun barrel outlet and a gas shroud outlet.

Sixth to tenth solving means relate to a thermal spraying apparatus corresponding to the above-described solving means according to the metallic film forming means, respectively. Specifically, sixth solving means according to the present invention provides a thermal spraying apparatus including an HVOF thermal spraying gun and means for supplying inert gas into a space defined inside of a cylindrical gas shroud in such a manner as to suppress oxidation and energize a particle velocity of metallic particles thermally sprayed from the thermal spraying gun, in which the gas shroud having a shape in conformity with that of the barrel cylindrical portion of the HVOF thermal spraying gun is detachably attached to the barrel cylindrical portion, characterized in that: the means for supplying the inert gas into the space defined inside of the gas shroud is constituted of a slit formed in a circumferential manner, and can energize the velocity of the metallic particles thermal sprayed by the thermal spraying gun and prevent mixture of the atmosphere.

Additionally, seventh solving means provides a thermal spraying apparatus characterized in that an inclination with respect to the spraying direction of the metallic particles thermally sprayed is provided at the slit formed in the circumferential manner, and thus, the inert gas is supplied into the space defined inside of the gas shroud along the inclination; and eighth solving means provides a thermal spraying apparatus characterized in that the inclination is within an angle of 70° with respect to a line perpendicular to the center axis of the shroud cylindrical portion.

In addition, ninth solving means provides a thermal spraying apparatus characterized in that the slits are arranged at a plurality of portions in a lengthwise direction of the gas shroud; and tenth solving means provides a thermal spraying apparatus characterized in that the slits are arranged at two or more portions including a thermal spraying gun barrel outlet and a gas shroud outlet.

As described above, according to the present invention, the cylindrical gas shroud is attached to the barrel of the HVOF thermal spraying apparatus, and the thermally sprayed metallic particles are controlled in such a manner as to form the thermally sprayed dense film of a small oxygen content with the inert gas supplied into the gas shroud without overheating the base plate. This unique configuration can produce the special function and effect that the thermally sprayed dense metallic film of a small oxygen content can be formed. With this unique configuration, there has never known yet that the particle velocity of the thermally sprayed metallic particle is accelerated, and further, the thermally sprayed dense metallic film of a small oxygen content is formed without overheating the base plate. In addition, the unique configuration and the special function and effect according to the present invention cannot be expected from the test results disclosed in the prior art literature.

With the above-described configuration, the present invention has succeeded in achieving the thermally sprayed dense metallic film of a small oxygen content is formed with reproducibility. Therefore, the present invention is a very basic and important invention which widely influences on various kinds of industrial fields in addition to its technical significance, thereby socially and economically producing a prominent effect with a remarkably high value.

### BRIEF DESCRIPTION OF THE DRAWINGS

FIG. 1 is a diagram illustrating the principle of a high velocity oxy-fuel (HVOF) thermal spraying apparatus;

FIG. 2 is a diagram illustrating the principle of a HVOF thermal spray apparatus having a gas shroud attached thereto;

FIG. 3 is a diagram illustrating the configuration of the gas shroud in a preferred embodiment;

FIG. 4 is a graph illustrating the relationship between the porosity and oxygen content in thermally sprayed stainless films formed under various conditions;

FIG. 5 is a graph illustrating the relationship between average particle velocity of thermally sprayed particles and the porosity of the film; and

FIG. 6 is a graph illustrating the relationship between an iron (i.e., substrate metal for the Hastelloy alloy thermally sprayed film) ion elusion curve and thermal spraying conditions.

### BEST MODES CARRYING OUT THE INVENTION

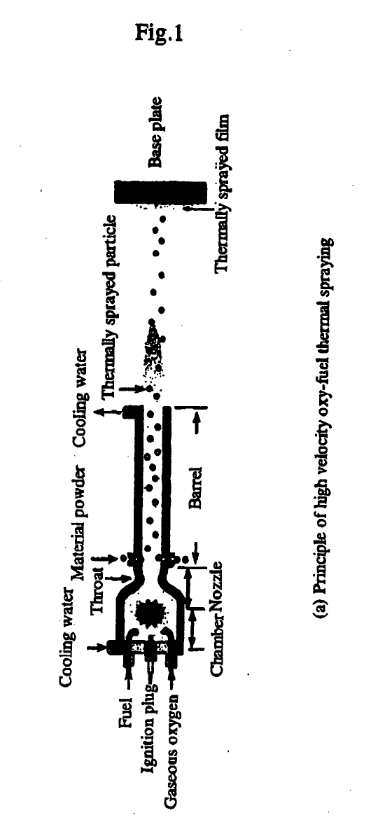

A description will be given below of an HVOF thermal spraying gun and a cylindrical shroud for use in a preferred embodiment according to the present invention. First of all, FIG. 1 is a schematic diagram illustrating the principle of high velocity oxy-fuel (HVOF) thermal spraying. The thermal spraying gun comprises a combustion chamber, a nozzle and a barrel. Fuel and oxygen are mixed and ignited inside of the combustion chamber, and then, the generated combustion flame is throttled once at a throat, before it passes the divergent nozzle and the straight barrel, to be thus discharged outside. As the fuel is used gas such as hydrogen, acetylene or propane or liquefied fuel such as kerosene. Material powder is sprayed Into the combustion flame at a divergent nozzle outlet with transporting gas by using a negative pressure at the divergent section, and then, is heated and accelerated inside of the barrel, to be thus discharged to the atmosphere. The material powder normally flies from about 20 cm to about 40 cm in the atmosphere, and then, is deposited on a base plate, thereby forming a film. Here, mechanical supplying means may be used in place of the means for supplying the material powder under the negative pressure.

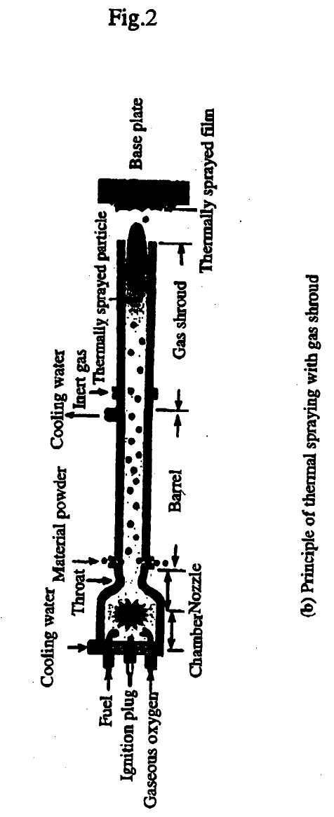

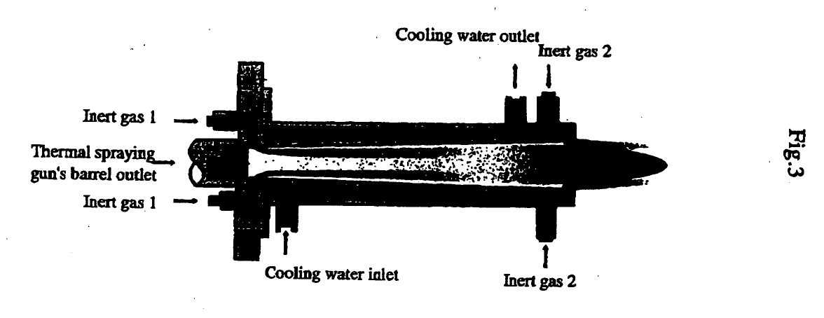

FIG. 2 is a schematic diagram illustrating the principle of the present invention in a state in which a shroud is attached to the HVOF thermal spraying gun illustrated in FIG. 1. FIG. 3 is a schematic diagram illustrating the gas shroud attachment, which consists of a water-cooled dual pipe structure.

Referring to FIG. 2 illustrating the principle of the present invention, in a metallic film forming method by using an HVOF thermal spraying gun according to the present invention, a metallic film is formed by the HVOF thermal spraying gun, in which a gas shroud having a cylindrical portion formed into a shape in conformity with that of a barrel cylindrical portion of the thermal spraying gun. Inert gas is supplied into a space defined inside of the shroud in such a manner as to suppress oxidation and energize the particle velocity, and metallic particles are accelerated to collide with a base plate without overheating the base plate, so as to form a thermally sprayed dense film having a low oxygen content at a relatively low temperature. Means for supplying the inert gas into the space defined inside of the gas shroud is constituted of a slit formed in a circumferential manner, and can energize the velocity of the metallic particles to be thermally sprayed and prevent any mixture of the atmospheric air.

Here, it is very important that the means for supplying the inert gas are the slits formed in the circumferential manner. The inert gas to be supplied from these circumferential slits forms a certain kind of dual-layered acceleration flow in such a manner as to cover the surroundings of the metallic particles thermally sprayed, energizes the velocity of the metallic particles, and functions to effectively suppress oxidation caused by the mixture of the atmosphere.

Although the slit in this case is preferably formed over the entire circumference, slits may be intermittently arranged in a circumferential manner, or a plurality of slits may be arranged. In order to form the above-described dual-layered acceleration flow, it is desirable that the interval between the slits and the length (i.e., the size) of the slits should be substantially the same in the arrangement of the slits.

The function and effect of the slits arranged in the circumferential manner become prominent owing to an inclined surface formed at the slit in a direction in which the metallic particles travel, as illustrated in FIG. 2.

In the case where the inclined surface is formed at the slit for supplying the inert gas into the space defined inside of the shroud, it is preferable that the inclination angle should be set within 70° with respect to a line perpendicular to the center axis of the shroud cylindrical portion.

A plurality of such slits may be arranged in a lengthwise direction of the gas shroud, The number of slit arrangement portions or arrangement positions may be determined in addition to the length of the gas shroud in consideration of the injection rate of the thermally sprayed metallic particles, the flow rate and quantity of the inert gas and the thickness and characteristics of the metallic film.

In arranging the slits at the plurality portions as described above, although the above-described inclined surfaces may be adopted at all of the slits or not, the formation of at least one inclination surface is effective. In this case, it is more preferable that the inclined surfaces should be formed at two or more portions, that is, at the outlet of a thermal spraying gun barrel and the outlet of a gas shroud in consideration of the formation of the above-described inclined surface at the slit formed at the outlet of thermal spraying gun barrel.

FIG. 3 illustrates the above-described gas shroud in a preferred embodiment. Inert gas (1) and inert gas (2) are supplied into the space defined inside of the shroud from two portions. The inert gas (1) is used for mainly accelerating the thermally sprayed particle. A gas supplying port is constituted of a slit formed over the entire circumference. This slit is arranged in the vicinity of the outlet of the thermal spraying gun barrel, and inclined surface at an appropriate angle in a combustion flame injection direction in such a manner as not to interfere the flow of the combustion flame. The other inert gas (2) is used for suppressing the mixture of oxygen from the atmosphere, and is supplied from the slit formed in the vicinity of the outlet of the gas shroud, Incidentally, in the embodiment illustrated In FIG. 3, no inclination is given to the slit for supplying the inert gas (2)

The inert gas for use is exemplified by noble gas such as argon or nitrogen. It is effective that the inner diameter of the shroud is gradually enlarged from the thermal spraying barrel outlet toward the shroud outlet, as in the embodiment illustrated in FIG. 3. In other words, the shroud is divergently tapered in the direction of the shroud outlet. A first reason of the effectiveness of the configuration in which the inner diameter of the shroud is gradually enlarged toward the shroud outlet resides in that since a combustion jet is gradually enlarged toward the atmosphere at the outlet, the turbulence of the flow is small, thereby making it difficult to decrease the velocity. In addition, a second reason resides in that the gradually enlarged inner diameter can prevent occurrence of inconvenience that the thermally sprayed powder adheres to the inner wall of the shroud, which might came clogging in a barrel having the same diameter.

Although the configurations of the thermal spraying gun and the shroud for use according to the present invention have been schematically described above, they need not be limited to the above-described configurations. As long as a required target is not missed, it is understood that variations and additions should be allowed.

Furthermore, the metal or base plate for thermal spraying may be selected from various kinds according to the present invention, and particularly, it is understood that the base plate may be selected from various kinds such as a flat plate, a curved plate, a bulk member and an odd-form molded product.

Hereinafter, the present invention will be described in more detail by way of preferred embodiments. Of course, the present invention is never limited to the preferred embodiments, described below.

Preferred Embodiments

(First Preferred Embodiment)

In the present preferred embodiment, stainless steel (SUS316L) powder was thermally sprayed by using a high velocity oxy-fuel thermal spraying apparatus in which a combustion flame of kerosene and oxygen are used as a heat source. The lengths of the barrel were two kinds, that is, 10 cm and 20 cm; nitrogen was used as the inert gas; and thus, the porosity and the oxygen content in the resultant film in each of the barrels were measured by varying the combustion condition (i.e., the mixture ratio of the fuel to oxygen) and the flow rate of gaseous nitrogen inside of the gas shroud.

Here, the gas shroud bad the configuration illustrated in FIG. 3. The inner diameter on the side of the outlet of the thermal spraying gun barrel was set to 20 mm; the inner diameter on the side of the outlet of the shroud was set to 30 mm; and the length of the shroud was set to 200 mm. The inclination surface at an angle of 45° with respect to a line perpendicular to the center axis of the shroud was formed at the entire circumferential slit for supplying the inert gas (1) in the vicinity of the outlet of the thermal spraying gas barrel. In contrast, no inclination was adopted at the entire circumferential slit for supplying the inert gas (2), in which the inert gas was supplied in a direction perpendicular to the center axis of the shroud. A distance from the nozzle outlet to the base plate was set to about 50 cm. Consequently, the distance from the outlet of the shroud to the base plate can be calculated by subtracting the length of the barrel and the length of the shroud from 50 cm. Specifically, in the case where the length of the barrel was 10 cm, 50−(10+20)−20 cm; or in the case where the length of the barrel was 20 cm, 50−(20+20)=10 cm.

The flow rate of the gaseous nitrogen as the inert gas (2) on the side of the outlet of the gas shroud was constantly 0.45 m³/min.

The supplied quantities and combustion pressures of the fuel and oxygen in oxidizing flame, neutral age flame and reducing flame and other thermal spraying conditions in the experiments are shown in Table 1 below.

Table 2 shows below values obtained in an experiment in which the length of the barrel and the flow rate of the inert gas (1) for the gas shroud influence on the average velocity and fusion rate of the thermally sprayed particles. These values are results under the condition where the mixture ratio of the fuel to oxygen achieves complete combustion. The particle velocity was measured by a non-contact optical measuring method; and the fusion rate was measured by separating a fused portion from a not-fused portion by capturing sprayed particles with an agar gel placed at the position of the base plate (this measurement was published and introduced in detail in Journal of the Japan Institute of Metals, 65 (2001) 317-22).

TABLE 1

| | oxidizing flame | neutral flame | reducing flame |
|---|---|---|---|
| | Ox | Ne | Re |
| kerosene flow rate | 0.33 | 0.41 | 0.44 |
| (l/min) | | | |
| oxygen flow rate | 860 | 670 | 600 |
| (std l/min) | | | |
| combustion pressure | 0.65 | 0.59 | 0.57 |
| (MPa) | | | |

| | |
|---|---|
| barrel length | 10, 20 |
| (cm) | |
| distance between | 50 |
| nozzle and base plate | |
| (cm) | |
| powder supplying | 60 |
| quantity | |
| (g/min) | |
| flow rate of shroud | 1.5, 2.5 |
| gas 1 | |
| (std m³/min) | |
| flow rate of shroud | 0.45 |
| gas 2 | |
| (std m³/min) | |

TABLE 2
Influence of barrel length and shroud gas flow rate on average
velocity and fusion rate of thermally sprayed particle

| | flow rate of shroud | average particle | |
|---|---|---|---|
| barrel length | gas | velocity | particle fusion rate |
| cm | std m³/min | m/s | % |
| 10 | non | 650 | 42 |
| | 2.5 | 672 | 13 |
| 20 | non | 741 | 62 |
| | 1.5 | 720 | 43 |
| | 2.5 | 767 | 38 |

The result first reveals that the particle velocity in the case of the barrel having a length of 20 cm is higher by about 100 m/s than that in the case of the barrel having a length of 10 cm. When the shroud is disposed in the barrel, and then, the gaseous nitrogen is made to flow at 2.5 m³/min, the velocity can be further increased by about 20 m/s in both of the barrels. Incidentally, a flow rate of 1.5 m³/min is insufficient in the case of the barrel having a length of 20 cm, and therefore, the velocity is decreased. This results in the findings that the flow rate should be desirably 2.0 m³/min or higher in the case of the barrel having a length of 20 cm.

Moreover, the particle fusion rate is decreased according to the shroud gas since the introduced gaseous nitrogen has a cooling effect at room temperature.

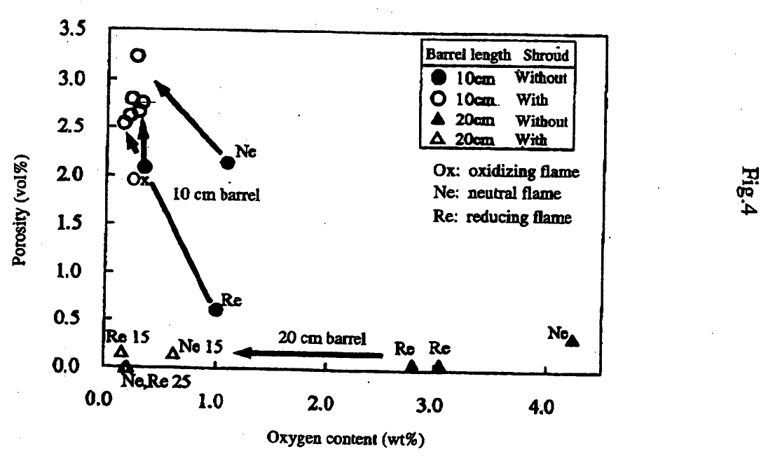

FIG. 4 shows measurement values of the porosity and the oxygen content in the thermal sprayed stainless steel films obtained under various kinds of conditions. Arrows in FIG. 4 indicate variations generated by the use of the gas shroud. In the case where the barrel having a length of 10 cm was used (indicated by circles), the oxygen content was markedly decreased under the combustion condition of the neutral flame and the reducing flame; in contrast, the effect was hardly produced under the combustion condition of the oxidizing flame, and further, the porosity was increased up to 2.5% or more. Since oxygen remains in the use of the oxidizing flame even if all of the fuel was exhausted, no suppressing effect on oxidation by the shroud could be expected.

Thus, as for the barrel having a length of 20 cm, a study was made on only the neutral flame and the reducing flame (indicated by triangles).

Here, numerals “15” and “25” in “Re 15”, “Ne 15” and “No, Re 25” in FIG. 4 express shroud gas flow rates 1.5 m³/min and 2.5 m³/min, respectively.

As is clear from FIG. 4, the oxygen content became as great as 3% or more in the case of no gas shroud. This is because the combustion flame could approach the base plate when the barrel was long (i.e., 20 cm), so that the base plate was over heated during the thermal spraying. However, in the case of the use of the shroud, the oxygen contained in the films could be suppressed down to a remarkably low level by the base plate cooling effect and the oxidation suppression during the flight of the thermally sprayed particles. In addition, when the shroud gas flow rate was 2.5 m³/min with the neutral flame and the reducing flame, the porosity became zero.

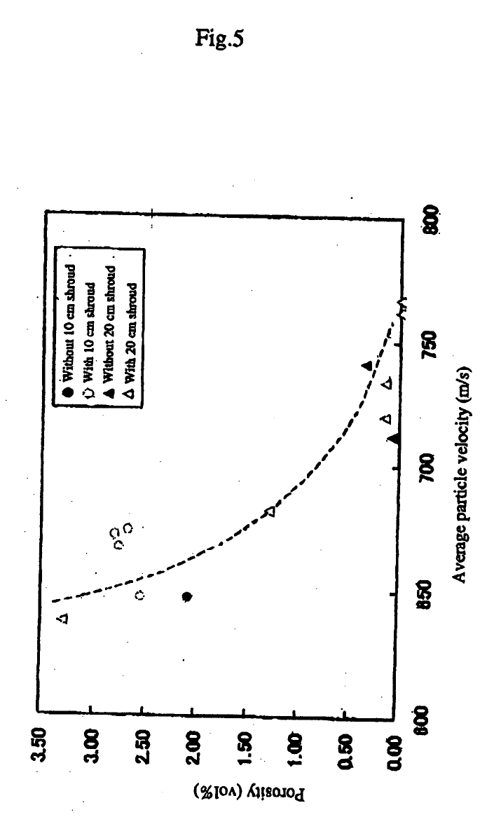

FIG. 5 is a graph obtained by re-plotting the porosity data illustrated in FIG. 4 on the lateral axis as the average velocity of the thermally sprayed particle. As is clear from FIG. 5, the particle velocity in excess of 750 m/s could be obtained by combining the barrel having a length of 20 cm with the gas shroud. In this case, both of the low oxygen content (i.e., 0.3% or less) and the porosity of zero could be achieved at the same time

(Second Preferred Embodiment)

Next, a description will be given below of results that gas shroud thermal spraying is applied to Hastelloy C alloy as one kind of nickel-based alloys in another preferred embodiment in which another material is used. It was found that even if the Hastelloy alloy was thermally sprayed under the standard condition by the commercially available HVOF thermal spraying apparatus, a considerably dense film excellent in corrosion resistance could be formed, and therefore, this invention was patentable (Jpn. Pat. No. 3,069,696, “Corrosion-Resistant Thermally Sprayed Film and Method for Fabricating the Same”), as described above.

The corrosion resistance in this case was judged from the result that the film was soaked in artificial seawater in a laboratory, and then, no corrosion could not be generated by evaluating the outside appearance, a potential and a corrosion resistance value even after a lapse of three months.

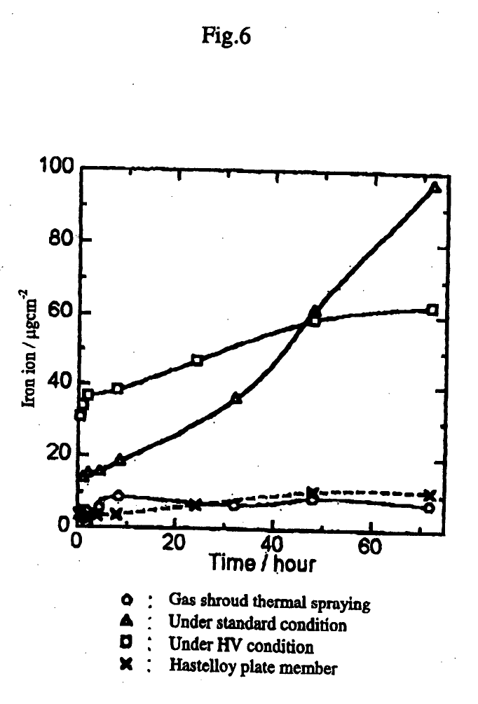

However, it was found thereafter that the corrosion resistance was insufficient in severe environment such as actual ocean in which waves wash, and therefore, a severer corrosion resistance evaluation test was conducted. Specifically, the Hastelloy alloy was thermally sprayed onto carbon steel, and then, an iron ion eluded when it was soaked in a 0.5 M HCl solution was quantified by a very sensitive analyzing method such as an ICP (Inductively Coupled Plasma) emission spectroscopy. At this time, since the base plate was sealed with a resin, the iron ions detected was mainly iron eluded from the base plate through fine pores in the thermally sprayed film (even if it could not be detected by the Mercury Porosimeter). This is a severer evaluation of the density of the film. FIG. 6 illustrates the measurement result of variations of iron ion elusion quantity as the time elapses. FIG. 6 is a graph showing the measurement results under a standard condition and an HV condition in addition to the Hastelloy plate material per se. Here, the standard condition and the HV condition are shown below in Table 3.

TABLE 3

| | Standard condition | HV condition |
|---|---|---|
| Kerosene flow rate | 0.38 | 0.47 |
| (l/min) | | |
| Oxygen flow rate | 862 | 1080 |
| (std l/min) | | |
| Combustion pressure | 0.68 | 0.86 |
| (MPa) | | |

| | |
|---|---|
| Barrel length | 10 |
| (cm) | |
| Distance between nozzle and | 50 |
| base plate | |
| (cm) | |
| Thermal spraying distance | 38 |
| (cm) | |

As is clear from FIG. 6, an increase in iron ion elusion quantity was observed after about 30 hours in a film obtained by thermal spraying the Hastelloy C alloy under the standard condition. Since the temperature was constant and no flow occurred in the artificial seawater in the laboratory, it was construed that a defect inducing the elusion like that was porously sealed with a generated corrosion product, and therefore, the corrosion could not proceed. However, as is clear from the result illustrated in FIG. 6, it was found that since the iron ion continued to be eluded in the actual ocean or severe acidic environment, the corrosion resistance was insufficient. In contrast, a film obtained under the HV condition was formed by increasing the quantities of the fuel and oxygen to be supplied to the HVOF thermal spraying apparatus (by about 25% more than that under the standard condition), so as to generate the higher-velocity combustion flame at a high pressure in the combustion chamber, and therefore, the resultant film became dense owing to the increase in particle velocity. However, in the case of this film, although an increase in elusion of the iron ion as the time elapsed was small, the level of the elusion of the iron ion was not low, and further, the iron ion was eluded immediately after the soaking. This was because the film was oxidized much. In the meantime, the elusion quantity from the film obtained by disposing the shroud (indicated by circles) was substantially the same as the result of the Hastelloy plate member indicated by a dotted line. Therefore, the iron base plate was hardly eluded, and the film per se was stable. Like the explanation made on the stainless steel, the cause was construed to suppress the oxidation of the film by disposing the gas shroud, so as to form the dense and clean Hastelloy film.

Summing up the test results described in the above first and second preferred embodiments, the film containing 0.3% or less of oxygen and having a porosity of 0 could be formed by using the neutral or reducing combustion flame and the barrel having a length of 20 cm and adding the gas shroud downstream to allow nitrogen to flow at 2.5 m³/min in the thermal spraying of the stainless steel SUS316L.

Furthermore, it were confirmed that the similar result could be produced even when the thermal spraying distance was varied from 50 mm to 160 mm (i.e., the distance from the outlet of the shroud tip to the base plate), or when the angle of the inclination surface was varied from 0° to 70°. Moreover, it was confirmed that the favorable effect could be produced in the same manner also in the case where the thermally sprayed metallic particles were sprayed from the outlet of the shroud tip slantwise at an angle of up to 45° to the perpendicular to the base plate.

Additionally, in the case of HVOF thermal spraying with the Hastelloy C alloy, although the film having a porosity of 0 could be already obtained under the normal thermal spraying condition as evaluated by the conventional Mercury Porosimeter, the corrosion resistance was insufficient in the severe corrosion environment (for example, in the actual ocean or in the 0.5 M HCI solution). However, no elusion of the iron ion into an acidic solution was observed by additionally disposing the gas shroud and thermal spraying the Hastelloy C alloy, and further, the film having the high corrosion resistance was formed.

The principal factor results from the effects that the higher velocity of the thermally sprayed particles, the maintenance of the inert atmosphere, and the suppression of the overheating of the base plate can be achieved at the same time according to the present invention. The present invention is applicable to other materials, and further, the principle based on the useful constituent requirement influences on other thermal spraying methods, or is applicable to other thermal spraying methods as it is.

### INDUSTRIAL APPLICABILITY

As described above, according to the present invention, the gas shroud is disposed in the HVOF thermal spraying gun and a great quantity of inert gas is supplied into the space defined inside of the shroud In such a manner as to suppress the oxidation and energize the particle velocity, and the metallic particles are made to collide with the base plate without overheating the base plate, so as to form the thermally sprayed dense film having the low oxygen content at the relatively low temperature, so that the function and effect, which could not be predicted from the test report disclosed in various kinds of literature reported up to now, can be produced: that is, the velocity of the thermally sprayed metallic particles can be increased, and the thermally sprayed dense metallic film having the low oxygen concentration can be formed without over heating the base plate. Therefore, the present invention is an epoch-making technique which can break a barrier experienced by the prior art. In addition to the remarkable enhancement of the corrosion resistance of the steel structural member and various kinds of equipment, the present invention is expected to be widely utilized in various fields including coating on the welds or ends of the various types of clad members, as well as repairing of damaged portion. Furthermore, the present invention is expected to provide an effective mean to prolong the lifetime of various steel structure of great industrial and economic importance.

1. A metallic film forming method by using an HVOF thermal spraying gun, in which a gas shroud having a cylindrical portion formed into a shape in conformity with that of a barrel cylindrical portion of the thermal spraying gun is disposed in the barrel cylindrical portion, inert gas is supplied into a space defined inside of the shroud in such a manner as to suppress oxidation and energize the particle velocity, and metallic particles are accelerated to collide with a base plate without overheating the base plate, so as to form a thermally sprayed dense film having a low oxygen content at a relatively low temperature, the metallic film forming method characterized in that:
means for supplying the inert gas into the space defined inside of the gas shroud is constituted of a slit formed in a circumferential manner, and can energize the velocity with respect to the metallic particles to be thermally sprayed by the thermal spraying gun and prevent any mixture of the atmosphere.

2. A metallic film forming method according to claim 1, characterized in that an inclination with respect to the spraying direction of the metallic particles to be thermally sprayed is provided at the slit formed in the circumferential manner, and thus, the inert gas is supplied into the space defined inside of the gas shroud along the inclination.

3. A metallic film forming method according to claim 2, characterized in that the inclination is within an angle of 70° with respect to a line perpendicular to the center axis of the shroud cylindrical portion.

4. A metallic film forming method according to claim 1, characterized in that the inert gas supplying means constituted of the slits formed in the circumferential manner are arranged at a plurality of portions in a lengthwise direction of the gas shroud.

5. A metallic film forming method according to claim 4, characterized in that the inert gas supplying means constituted of the slits formed in the circumferential manner are arranged at two or more portions including a thermal spraying gun barrel outlet and the gas shroud outlet.

6. A thermal spraying apparatus including an HVOF thermal spraying gun and means for supplying inert gas into a space defined inside of a cylindrical gas shroud in such a manner as to suppress oxidation and energize the particle velocity of metallic particles thermally sprayed from the thermal spraying gun, in which the gas shroud having a shape in conformity with that of the barrel cylindrical portion of the HVOF thermal spraying gun is detachably attached to the barrel cylindrical portion, the thermal spraying apparatus characterized in that:
the means for supplying the inert gas into the space defined inside of the gas shroud is constituted of a slit formed in a circumferential manner, and can energize the velocity of the metallic particles thermally sprayed by the thermal spraying gun and prevent mixture of the atmosphere.

7. A thermal spraying apparatus according to claim 6, characterized in that an inclination with respect to the spraying direction of the metallic particles thermally sprayed is provided at the slit formed in the circumferential manner, and thus, the inert gas is supplied into the space defined inside of the gas shroud along the inclination.

8. A thermal spraying apparatus according to claim 7, characterized in that the inclination is within an angle of 70° with respect to a line perpendicular to the center axis of the shroud cylindrical portion.

9. A thermal spraying apparatus according to claim 6, characterized in that the inert gas supplying means constituted of the slits formed in the circumferential manner are arranged at a plurality of portions in a lengthwise direction of the gas shroud.

10. A thermal spraying apparatus according to claim 9, characterized in that the inert gas supplying means constituted of the slits formed in the circumferential manner are arranged at two or more portions including a thermal spraying gun barrel outlet and a gas shroud outlet.

11. A metallic film forming method according to claim 2, characterized in that the inert gas supplying means constituted of the slits formed in the circumferential manner are arranged at a plurality of portions in a lengthwise direction of the gas shroud.

12. A metallic film forming method according to claim 3, characterized in that the inert gas supplying means constituted of the slits formed in the circumferential manner are arranged at a plurality of portions in a lengthwise direction of the gas shroud.

13. A thermal spraying apparatus according to claim 7, characterized in that the inert gas supplying means constituted of the slits formed in the circumferential manner are arranged at a plurality of portions in a lengthwise direction of the gas shroud.

14. A thermal spraying apparatus according to claim 8, characterized in that the inert gas supplying means constituted of the slits formed in the circumferential manner are arranged at a plurality of portions in a lengthwise direction of the gas shroud.
